(19) United States
(12) Patent Application Publication
(10) Pub. No.: US 2015/0157169 A1
(43) Pub. Date: Jun. 11, 2015

(54) SYSTEM AND METHOD FOR PREPARING A BEVERAGE

(71) Applicant: EUGSTER/FRISMAG AG, Amriswil (CH)

(72) Inventors: Marc Krüger, Bergisch Gladbach (DE); Günter Empl, Bergisch Gladbach (DE)

(21) Appl. No.: 14/411,600

(22) PCT Filed: Jun. 28, 2013
(86) PCT No.: PCT/EP2013/063656

§ 371 Date: Dec. 29, 2014

(30) Foreign Application Priority Data
Jun. 29, 2012 (DE) 10 2012 105 787.7

(51) Int. Cl. A47J 31/44; A23F 5/26; A47J 31/40

(52) U.S. Cl. CPC A47J 31/4492; A47J 31/407; A23F 5/262

(57) ABSTRACT

The invention relates to a system for preparing a beverage, comprising a portion capsule, which contains a beverage raw material, and a brewing device which comprises a brewing chamber for receiving the portion capsule and for extracting the beverage from the portion capsule by means of hot water. Said portion capsule comprises an identifier and said brewing device comprises an identifier detector for identifying the identifier of the portion capsule.

### PRIOR ART

The invention relates to a system for preparing a beverage, comprising a portion capsule which contains a beverage raw material, and a brewing device which comprises a brewing chamber for receiving the portion capsule and for extracting the beverage from the portion capsule by means of hot water.

Such a system is known for example from publication DE 10 2011 011 204 A1. The system comprises a portion capsule and a brewing device with a brewing chamber for extracting and/or dissolving a substance provided in the portion capsule. The brewing chamber comprises a first brewing chamber element and a second brewing chamber element and the first brewing chamber element can be moved between a loading position, in which the first and the second brewing chamber element are at a distance from one another, and an extraction position, in which the first and the second brewing chamber element are brought close to each other to create an essentially closed brewing chamber. Each brewing chamber element comprises a perforation means, wherein the capsule portion cover can be pierced using the first perforation means and the bottom area of the portion capsule can be pierced using the second perforation means. The portion capsule is therefore especially designed to be used with the brewing device so as to ensure a trouble-free and reliable brewing process as well as a high quality of the beverage to be produced.

The popularity of such portion capsule brewing systems has steadily risen in recent years, which means that, now, a variety of different portion capsule systems can be found on the market. The portion capsules and the brewing chamber machines of the various systems frequently differ from each other externally only slightly, even though the internal structure and the particular properties of the portion capsules differ greatly from one another. Disadvantageously, therefore, there exists for the consumer the risk that he might accidentally use portion capsules of one portion capsule system in a brewing device of a different portion capsule system for the production of a beverage, which may give rise to significant damage to the brewing device. It is conceivable, for example, that the perforation means of a brewing unit, which are normally simply provided to penetrate a very thin sealing film of the appropriate portion capsule, bend or even break, if they are operated with a non-system portion capsule which comprises a rigid and stable distribution and/or filter element directly beneath the sealing film.

### DISCLOSURE OF THE INVENTION

The purpose of the present invention was, therefore, to provide a system for the preparation of a beverage using portion capsules, wherein the operation of the brewing device with non-system portion capsules is prevented.

The purpose is achieved with a system for the preparation of a beverage comprising a portion capsule which contains a beverage raw material, and a brewing device comprising a brewing chamber for receiving the portion capsule and for extracting the beverage from the portion capsule by means of hot water, wherein the portion capsule comprises an identifier, and the brewing device comprises an identifier detector to identify the identifier of the portion capsule.

The system according to the invention advantageously allows the portion capsule to be examined before the brewing device is put into operation so as to determine whether the particular portion capsule is an approved and known portion capsule, i.e. one of the system's own portion capsules, thereby ensuring that no risk arises for the brewing device. It is conceivable, for example, that the brewing chamber will not close or that the portion capsule simply falls through the brewing chamber, or that the brewing process will not be started if the portion capsule cannot be uniquely identified by means of its identifier. This prevents the brewing device from being operated with a non-system portion capsule which does not have a verifiable identifier. The risk of damaging the brewing device due to the commissioning of the brewing device with such non-system portion capsules is advantageously completely eliminated, without the need for increased awareness on the part of the consumer.

Advantageous embodiments and further developments of the invention can be extracted from the subordinate claims as well as the description with reference to the drawings.

According to a preferred embodiment of the present invention, the brewing device comprises an insertion shaft for inserting a portion capsule into the brewing device, wherein the identifier detector is arranged in the area of the insertion shaft, in particular in a wall of the insertion shaft. Advantageously, when the portion capsule is inserted, it can be checked to determine whether it is one of the system's own portion capsules. It is conceivable that the portion capsule is not accepted by the retaining means, if it is detected that the portion capsule is a non-system portion capsule, which means that the portion capsule falls past the brewing chamber into a waste container for used portion capsules.

According to a preferred embodiment of the present invention, it is provided that the identifier detector is arranged in the area of the brewing chamber, in particular in a wall of the brewing chamber. Advantageously, therefore, the portion capsule can be checked in the brewing chamber to determine whether it is one of the system's own portion capsules or a non-system capsule portion. Preferably, the identifier detector comprises a resistance measuring device for determining the electrical resistance of the portion capsule or of part of the portion capsule. The use of a resistance measuring device is practicable, in particular in the brewing chamber, since only in the brewing chamber can a positive contact between an outer surface of the portion capsule and contacts of the resistance measurement device be guaranteed. Such a positive contact is crucial for the reliable measurement of an actual resistance measurement. It is conceivable that the resistance measurement is carried out following the introduction of the brewing liquid into the portion capsule, since the portion capsule expands through the pressurised brewing liquid and therefore a low-resistance electrical contact between the outer surface of the portion capsule and contacts of the resistance measuring device can be achieved.

According to a preferred embodiment of the present invention, it is provided that the resistance measuring device comprises a first contact point for making contact with the portion capsule and a second contact point for making contact with the portion capsule, wherein the resistance measuring device comprises a measuring device for measuring the electrical resistance between the first and the second contact point. Preferably, the conductivity of a material of the portion capsule between the two contact points is measured by the two contact points. It is conceivable that a strip of an electrically conductive material is disposed on the outer surface of the portion capsule, the conductivity of which is measured, or that the conductivity of the material of the capsule wall itself is measured. In this case, the capsule wall itself is made, for example, from a conductive plastic. Furthermore, it is conceivable that the conductivity of a cover-sealing film for the portion capsule, which can be made from aluminium for example, is measured. The material is in any case designed such that its conductivity differs significantly from the conductivity of typical portion capsules of other portion capsule systems, with the result that, on the basis of the measured conductivity, a reliable distinction can be made between whether the portion capsule to be measured is a non-system portion capsule or one of the system's own portion capsules.

According to a preferred embodiment of the present invention, it is provided that the first and second contact points are integrated into the wall of the brewing chamber at different locations such that, in the extraction position, a positive contact is produced between the first contact point and a first outer area of the portion capsule and between the second contact point and a second outer area of the portion capsule. Advantageously, the portion capsule expands when the brewing liquid is introduced inside the portion capsule, with the result that a low-resistance electrical contact is ensured both between the first contact point and the first outer area of the portion capsule and between the second contact point and the second outer area of the portion capsule. The first and second outer areas are formed, in particular, in the side wall of the portion capsule. It is also conceivable that the first outer area comprises a cover flange or a sealing film of the portion capsule, while the second outer area comprises the side wall of the portion capsule base of the portion capsule. Of course, it is also conceivable that the first outer area comprises the side wall of the portion capsule, while the second outer area comprises the portion capsule base. Preferably, in each case, the first and the second contact points comprise an electrically conductive and, in particular, a metallic area in the wall of the brewing chamber.

According to a preferred embodiment of the present invention, it is provided that the brewing chamber comprises a receiving element and a closure element, wherein the closure element [verb missing] relative to the receiving element between a loading position, in which the closure element and the receiving element are at a distance from one another, and an extraction position, in which the closure element and the receiving element are brought close to each other to create the essentially closed brewing chamber, wherein the identifier detector is disposed in the receiving element and/or the closure element. Advantageously, the electrical conductivity of any section of the portion capsule can therefore be measured. Preferably, a portion capsule introduced into the brewing device through an insertion shaft is retained on the closure element by means of retaining elements when the closure element is in the loading position, wherein the identifier detector is disposed in the retaining elements.

According to a preferred embodiment of the present invention, it is provided that one of the two retaining elements comprises the first contact point and the other of the two retaining elements comprises the second contact point. Advantageously, it can therefore be checked, before the brewing chamber is closed, whether the portion capsule located in the intermediate position is one of the system's own portion capsules, as the retaining elements always necessarily produce a contact with the portion capsule when a new portion capsule is filled. It is conceivable that the closure element cannot be moved into the extraction position when a non-system portion capsule is detected or that the closure element makes a short motor-controlled forward movement in the direction of the receiving element followed by a motor-controlled backward movement into the loading position in particular by means of an actuator, with the result that the non-system portion capsule is automatically ejected into the waste container. Alternatively, it is also conceivable that the receiving element comprises a first and/or second perforation means, which acts as a first or second contact point, wherein the second perforation means is preferably made of metal or an electrically conductive plastic. It is conceivable that the second perforation means is used for contacting. Advantageously, therefore, a low-resistance contact between the contact point of the identifier detector and the portion capsule can be guaranteed, as the second perforation means must, in any event, be driven by the base section of the portion capsule. It is also conceivable that a filter element, which is located in the area of the base section in the interior of the portion capsule, comprises the identifier, wherein the second perforation means makes contact with the filter element when the capsule base is perforated and therefore makes it possible to detect the identifier. The first perforation means is provided, in particular, for perforating the capsule cover.

Alternatively, it is also conceivable that the receiving element comprises a first and/or second perforation means, which functions as a first contact point, and wherein the two retaining elements together form two second contact points. Preferably, a metallic capsule cover makes contact with the perforation means, with the result that an electrical resistance decreasing over the capsule flange (contacted through the retaining elements) and the capsule cover can be used to identify the identifier.

Preferably, the receiving element comprises a second perforation means, in particular for the perforation of the capsule base, which functions as a first contact point, and wherein the closure element comprises at least a first perforation means, which functions as a second contact point. In this way, it is possible that an electrical resistance decreasing over the entire capsule can be used to identify the identifier. Due to the use of the perforation means as a contact point a reliable and low-resistance contact is also possible.

According to a preferred embodiment of the present invention, it is provided that the brewing device comprises a pump for introducing brewing liquid into the brewing chamber under pressure, wherein the pump is switched on by means of a control circuit and wherein the control circuit comprises a switch, which only permits the pump to be switched on when the identifier detector detects a specific identifier on the portion capsule. It is conceivable that the control circuit comprises a control element, which switches the pump on, when the conductivity in the portion capsule measured by means of the resistance measuring device has a predefined value.

According to a preferred embodiment of the present invention, it is provided that the identifier detector comprises an induction measuring device for measuring an electromagnetic field induced by the portion capsule. It is conceivable, for example, that the portion capsule comprises a magnetic material, which induces an electromagnetic field when the portion capsule moves. Preferably, the induction measuring device is integrated into the wall of the insertion shaft, through which the portion capsule falls in the direction of the brewing chamber under the influence of gravity when the brewing device is being loaded. The movement of the portion capsule when it falls through the insertion shaft produces an electromagnetic field, which is detected by the induction measuring device and is used to distinguish between one of the system's own portion capsules and a non-system portion capsule.

According to a preferred embodiment of the present invention, it is provided that the identifier detector comprises a magnetic switch, which is activated by means of a magnet disposed on or in the portion capsule, its magnetic field functioning as an identifier. The magnetic switch is arranged for this purpose, for example, in the area of the insertion shaft and/or in the area of the brewing chamber. The magnetic switch functions in particular as a simple switch in the control circuit for switching on the pump, with the result that a particularly cost-effective implementation is possible.

A further object of the present invention is a method for preparing a beverage by means of the system according to the invention, wherein, in a first step, the portion capsule is inserted into the brewing device, wherein, in a second step, the identifier of the portion capsule is identified by means of the identifier detector and wherein, in a third step, the portion capsule is transferred into the brewing chamber and/or the extraction process is started, when the identifier of the portion capsule has been identified. Advantageously, the inventive method ensures that the portion capsule is only disposed in the closed brewing chamber if it is one of the system's own portion capsules. Otherwise, the brewing chamber is prevented from closing and/or the portion capsule is not received and falls into a waste container located beneath the brewing chamber in order to prevent the brewing chamber from being damaged through the introduction of a non-system portion capsule. Alternatively, it is conceivable that the extraction process and, in particular, the pump for introducing the brewing liquid are only started when the existence of one of the system's own portion capsules is detected in the second step. This also prevents the brewing chamber from being damaged through the extraction of a non-system portion capsule. It is conceivable that, in a second step, the conductivity of the portion capsule is measured by means of a resistance measuring device, or that an electromagnetic field induced by the movement of the portion capsule through the insertion shaft is measured by means of an induction measuring device.

Preferably, in the second step, the detected identifier is compared with stored reference identifiers. Alternatively, it is also conceivable, however, that the control circuit for switching the pump on is designed such that the pump is only switched on when an ohmic resistance (across the portion capsule) which lies in a predefined range is measured between the first and the second contact point of the resistance measuring device.

Further details, features and advantages of the invention can be derived from the drawings as well as from the following description of preferred embodiments with reference to the drawings. The drawings illustrate merely exemplary embodiments of the invention, which do not limit the essential idea of the invention.

### BRIEF DESCRIPTION OF THE FIGURES

FIGS. 1a to 1e show schematic sectional views of a system and a method for producing a beverage according to a first embodiment of the present invention.

FIG. 2 shows a schematic sectional view of a system and a method for producing a beverage according to a second embodiment of the present invention.

### EMBODIMENTS OF THE INVENTION

The same parts are denoted in all the figures by the same reference signs and are therefore, as a rule, also named and/or mentioned just once.

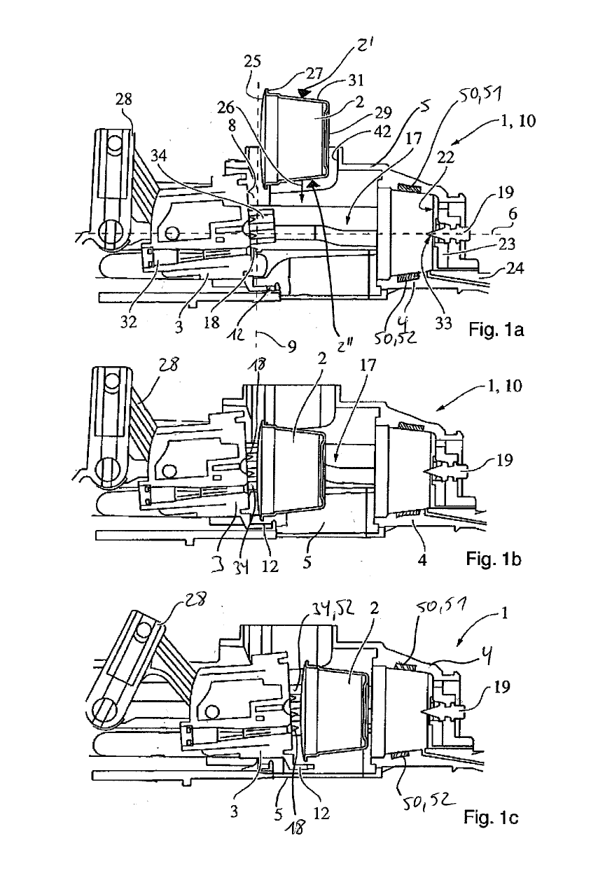

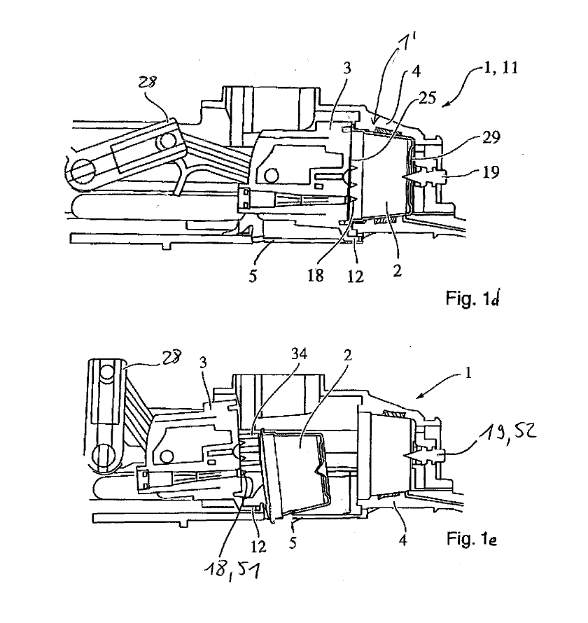

FIGS. 1a to 1e show schematic sectional views of a system (1) and a method for producing a beverage according to a first embodiment of the present invention. The system (1) comprises a brewing device (5) and a portion capsule (2). The brewing device (1) [sic] comprises a receiving element (4) and a closure element (3) designed as a bell element. The closure element (3) is movable relative to the receiving element (4) along an axial direction (6) between a loading position (10) illustrated in FIGS. 1a and 1b and an extraction position (11) illustrated in FIG. 1d.

The portion capsule (2) comprises a truncated cone (31) made of plastic in a pot-shaped design. The truncated cone (31) is hermetically sealed by means of a capsule cover (25) made of plastic or aluminium film. Inside the portion capsule (2) there is a beverage substance, in particular a roast coffee powder extractable by means of an extraction liquid. Optionally, the portion capsule (2) comprises a filter element (not shown), which is arranged between the capsule base (29) and the beverage substance. The capsule cover (25) is glued or welded to the truncated cone (31) in the area of a capsule flange (27). The truncated cone (31) is made of an electrically conductive plastic, in particular deep-drawn, which comprises a well-defined electrical conductivity as identifier for the identification of the portion capsule (2).

The closure element (3) comprises a large number of first perforation means (18) on an end face (8) facing the receiving element (4). The first perforation means (18) each comprises a perforation spike, which sticks out from the end face (8) in the direction of the receiving element (4). Further, water-outlet openings are designed in the end face (8) (impossible to make out in FIGS. 1a to 1e for reasons of perspective). The closure element (3) also comprises a water supply channel (32), which is provided for the delivery of extraction liquid to the water-outlet openings. The closure element (3) comprises two lateral holding arms (34), the free ends of which face each other and laterally comprise the capsule flange (27). The receiving element (4) comprises a second perforation means (19), which comprises a piercing spike pointing in the direction of the closure element (4) [sic], which is disposed inside the cavity. The piercing spike is provided with lateral grooves (33), which run parallel to the axial direction (6). In the area of the piercing spike, the receiving element (4) comprises a depression (23) in the bottom area (22) of the cavity, in which an outlet channel (24) flows.

FIG. 1a illustrates the closure element (3) in the loading position (10), i.e. the closure element (3) is spaced from the receiving element (4) along the axial direction (6). In this starting position, the portion capsule (2) is introduced into the insertion shaft (42) by a user (not illustrated) along a load direction (26), with the result that the portion capsule (2) falls under the influence of gravity into an intermediate area between the closure element (3) and the receiving element (4).

FIG. 1b illustrates that the portion capsule (2) comes into contact with a capsule stop (12) in the intermediate area and rests there. At the same time, the portion capsule (2) is prevented from tilting in the direction of the receiving element (4) by means of the lateral holding arms (35), as the capsule flange (27) is supported on the holding arms (34) in the direction of the receiving element (4), with the result that the portion capsule (2) is essentially axially aligned along the axial direction (6).

In the next step, illustrated in FIG. 1c, the closure element (3) is driven to a linear displacement along the axial direction (6) in the direction of the receiving element (4) using a toggle joint (28). The portion capsule (2) is introduced into the cavity of the receiving element (21) through the movement of the closure element (3).

In FIG. 1d the closure element (3) is pushed along the axial direction (6) into the extraction position (11) as far as the receiving element (4), with the result that the portion capsule (2) is almost completely introduced into the cavity of the bell element (21). The capsule cover (25) is thereby perforated by the first perforation means (18) designed as perforation spikes, whilst the capsule base (29) is perforated by the second perforation means (19) designed as a piercing spike. The first and the second closure element (3, 4) form a hermetically sealed brewing chamber (1′), in which the portion capsule (2) is arranged. The capsule flange (27) is thereby firmly clamped between the first and the second closure element (3, 4), in particular by means of an elastic sealing washer (36). The capsule stop (12) is thereby arranged beneath the receiving element (4).

The brewing device (5) comprises an identifier detector (50) in the form of a resistance measuring device. The resistance measuring device comprises a first contact point (51) and a second contact point (52), each of which is made of an electrically conductive material, which is flush mounted into the inner wall of the closure element (4). The resistance measuring device is designed to measure the ohmic resistance between the first contact point (51) and the second contact point (52). When the brewing chamber (1′) closes and a portion capsule (2) is arranged in the closed brewing chamber (1′), the first contact point (51) comes into contact with the first external area (2′) of the portion capsule (2), while the second contact point (52) comes into contact with a second contact area (2″) of the portion capsule (2). The resistance measuring device therefore measures the electrical conductivity of the portion capsule (2) in an area between the first and the second external area (2′, 2″). On the basis of the measured electrical conductivity, the decision is taken whether the portion capsule (2) in the brewing chamber (1′) is one of the system's own portion capsules (2) or a non-system portion capsule (2). If the measured ohmic resistance lies, for example, within a predefined range and/or exceeds or falls below a predefined threshold, it is assumed that the portion capsule (2) is one of the system's own portion capsules (2), which can be extracted without hesitation by means of the brewing device (1). This then closes a control circuit, which enables a pump (not shown) to be switched on to convey extraction liquid, whereby the extraction liquid is fed into the brewing chamber (1′) in the form of pressurised and heated water. The extraction liquid is thereby conveyed by means of the pump through the water supply channel (32) to the water-outlet openings and, from there, reaches the portion capsule (2) through the perforation openings in the capsule cover (25) produced by the first perforation means (18). The extraction liquid flows through the beverage substance, with the result that a beverage extract is formed, which once again leaves the portion capsule (2) through the perforation hole produced in the capsule base (29) by the piercing spike and then arrives in the outlet channel (24). By means of the outlet channel (24), the beverage extract is fed directly to a drinking vessel (not shown) such as a coffee cup, for example.

As illustrated in FIG. 1e, after the extraction process, the closure element (3) is moved from the extraction position (11) back in the direction of the loading position (10). The extracted portion capsule (2) is thereby pulled by the holding arms (34) back out of the cavity of the receiving element (4) and transported in the direction of the loading position (10). The retraction of the receiving element (4) causes the capsule flange (27) to come into contact with a contact surface of a capsule ejector facing the receiving element (4). The used portion capsule (2) falls through it under the influence of gravity into a collection receptacle (not shown) arranged beneath the intermediate area. Then, the closure element (3) is back in the loading position (10), with the result that the brewing device (1) can be re-filled with an unused portion capsule (2) according to FIG. 1a.

If the measured conductivity lies outside the predefined range, the control circuit remains unbroken, with the result that the pump cannot be switched on and the non-system portion capsule is prevented from being extracted. It is conceivable that a corresponding visual or acoustic error signal is generated, which signals the incompatibility of the portion capsule (2) used to the user of the system (1). Alternatively, it would be conceivable that the brewing chamber (1′) is opened by means of the automatic retraction of the closure element (3), thereby causing the non-system portion capsule (2) to be automatically ejected into the collection receptacle.

In an alternative embodiment, it would be conceivable that the resistance measuring device is integrated into the holding arms (34), with the result that, even before the brewing chamber (1′) is closed, a check can be carried out into whether the portion capsule (2) retained by the holding arms (34) in the intermediate position is a non-system portion capsule (2) or one of the system's own portion capsules (2). It is conceivable that the brewing chamber (1′) is actively prevented from closing and/or that the portion capsule (2) is automatically ejected into the collection receptacle, if a non-system portion capsule (2) is detected. In this embodiment, one holding arm (34) preferably functions as a first contact point (51), while the other holding arm (34) functions as a second contact point (52). In this case, the conductivity is measured, in particular, at the capsule flange (27) and/or at the capsule cover (25).

In an alternative embodiment, the first perforation means (18) and the second perforation means (19) functions as part of the identifier detector (50), wherein the first perforation means (18) serves as a first contact point (51) and the second perforation means (19) serves as a second contact point (52). The identifier detector (50) then measures the electrical resistance decreasing over the portion capsule (2) between the first perforation means (18) and the second perforation means (19). It is also conceivable that only the first perforation means (18) or only the second perforation means (19) functions as a first contact point (51), while the retaining means (34) or a wall area of the brewing chamber (1′) functions as a second contact point (52).

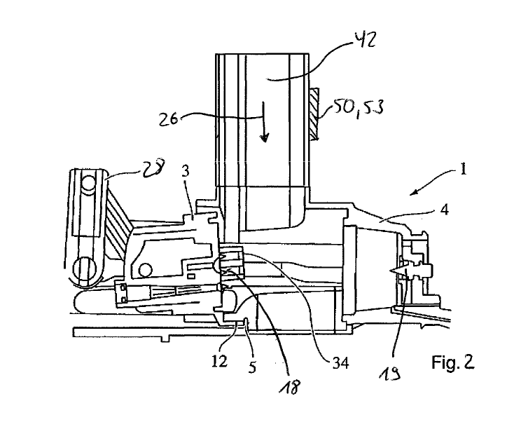

FIG. 2 shows a schematic sectional view of a system (1) for producing a beverage according to a second embodiment of the present invention. The system (1) according to the second embodiment is essentially the same as the system (1) according to the first embodiment illustrated in FIGS. 1a to 1e, the difference in the second embodiment being that the brewing device (5) comprises an identifier detector (50) in the form of an induction measuring device (53). The brewing device (5) comprises an extended insertion shaft, in the wall of which the induction measuring device (53) is arranged.

The portion capsule (2) which, for reasons of clarity, is not shown, comprises an identifier in the form of a magnetic material, which is preferably disposed inside the portion capsule (2) or integrated into the capsule material, for example of the truncated cone (31) of the capsule cover (25). If the portion capsule (2) falls through the insertion shaft (42) under the influence of gravity and therefore moves past the induction measuring device (53), the induction measuring device (53) detects a specific electromagnetic field, which is induced by the movement of the magnetic material. If the properties of the detected electromagnetic field, in particular the energy flow density or such like, lies within a predefined range or above a predefined threshold, it is assumed that one of the system's own portion capsules (2) has been inserted into the brewing device (2) [sic]. The brewing chamber (1′) is then allowed to be closed and the portion capsule (2) to be extracted. If the properties are outside the predefined values, it is assumed that the portion capsule (2) is a non-system portion capsule (2). It is conceivable that the control circuit is then interrupted, with the result that the pump cannot be switched on and the non-system portion capsule (2) is prevented from being extracted. Alternatively, it is conceivable that a corresponding visual or acoustic error signal is generated, which signals the incompatibility of the portion capsule (2) used to the user of the system (1). Alternatively, it would also be possible that the portion capsule (2) in the intermediate area is not collected by the capsule stop (12) but, instead, falls directly through the intermediate area into the collection receptacle. For this to happen, the capsule stop (12) is, for example, automatically retracted or the closure element (3) is moved by means of the motor even further away from the receiving element (4). The induction measuring device (53) comprises, in particular, an electrical conductor designed as a loop, in which a flow of electricity is induced by the electromagnetic field to be measured.

In an alternative embodiment, the brewing device comprises, instead of the resistance measuring device shown in FIGS. 1a to 1e or instead of the induction measuring device (52) shown in FIG. 2, a magnetic switch which is activated by means of magnet located in or on the portion capsule (2). It is conceivable that the magnetic switch activates a control circuit such that the pump can be switched on, when one of the system's own portion capsules with a big enough magnet is arranged inside the brewing chamber (1′) and/or moved through the insertion shaft (42).

### LIST OF REFERENCES

1 System
1′ Brewing chamber
2 Portion CAPSULE
2′, 2″ First and second external area
3 Closure element
4 Receiving element
5 Brewing device
6 Axial direction
8 End area
10 Loading position
11 Extraction position
12 Capsule stop
18 First perforation means
19 Second perforation means
22 Bottom area
23 Depression
25 Capsule cover
26 Load direction
27 Capsule flange
28 Toggle joint
29 Capsule base
31 Truncated cone
32 Water supply channel
33 Grove
34 Holding arm
42 Insertion shaft
50 Identifier detector
51 First contact point
52 Second contact point
53 Induction measuring device

1. System (1) for preparing a beverage, comprising a portion capsule (2), which contains a beverage raw material, and a brewing device (5), which comprises a brewing chamber for receiving the portion capsule (2) and for extracting the beverage from the portion capsule (2) by use of extraction liquid, characterised in that the portion capsule (2) comprises an identifier and that the brewing device (5) comprises an identifier detector (50) for the identification of the identifier of the portion capsule (2), wherein a portion capsule (2) introduced into the brewing device (5) by use of an insertion shaft (42) is retained on the closure element (3) by use of retaining elements (34), when the closure element (3) is in the loading position (10), wherein the identifier detector (50) is arranged in the retaining elements (34).

2. System (1) according to claim 1, wherein the brewing device (5) comprises an insertion shaft (42) for the introduction of a portion capsule (2) into the brewing device (5), wherein the identifier detector (50) is arranged in the area of one or both of the insertion shaft (42) and the area of the brewing chamber (1′).

3. System (1) according to claim 1, wherein the brewing chamber comprises a receiving element (4) and a closing element (3), wherein the closing element (3) [verb missing] relative to the receiving element (4) between a loading position (10), in which the closure element (3) and the receiving element (4) are at a distance from one another, and an extraction position (11), in which the receiving element (4) and the closure element (3) are brought close to each other to create the essentially closed brewing chamber (1′), wherein the identifier detector (50) is disposed in the receiving element (4) and/or in the closure element (3).

4. System (1) according to claim 1,
wherein the brewing device (5) comprises a pump for introducing extraction liquid into the brewing chamber under pressure, wherein the pump is switched on by means of a control circuit and wherein the control circuit comprises a switch, which only permits the pump to be switched on when the identifier detector (50) detects a specific identifier on the portion capsule (2).

5. System (1) according to claim 1, wherein the identifier detector (50) comprises a resistance measuring device to determine the electrical resistance of the portion capsule (2) or of part of the portion capsule (2).

6. System (1) according to claim 5, wherein the resistance measuring device comprises a first contact point (51) for making contact with the portion capsule (2) and a second contact point (52) for making contact with the portion capsule (2), wherein the resistance measuring device for measuring the electrical resistance between the first and the second contact point (51, 52) is configurable.

7. System (1) according to claim 6, wherein the first and the second contact point (51, 52) are each integrated into the wall of the brewing chamber (1′) at different positions such that, in the extraction position (11), a positive contact is produced between the first contact point (51) and a first outer area (2′) of the portion capsule (2) and between the second contact point (52) and a second outer area (2″) of the portion capsule (2).

8. System according to claim 6, wherein one of the two retaining elements (34) comprises the first contact point (51) and the other of the two retaining elements (34) comprises the second contact point (52).

9. System according to claim 3, wherein the receiving element (4) comprises a second perforation means (19), which functions as a first or second contact point (51, 52), wherein the second perforation means (19) is preferably made of metal or an electrically conductive plastic.

10. System according to claim 6, wherein the receiving element (4) comprises a second perforation means (19), which functions as a first contact point (51), and wherein both retaining elements (34) together form two second contact points (52).

11. System according to claim 6, wherein the receiving element (4) comprises a second perforation means (19), which functions as a first contact point (51), and wherein the closure element (3) comprises at least a first perforation means (18), which functions as a second contact point (52).

12. System (1) for preparing a beverage, comprising a portion capsule (2), which contains a beverage raw material, and a brewing device (5), which comprises a brewing chamber for receiving the portion capsule (2) and for extracting the beverage from the portion capsule (2) by use of extraction liquid, characterised in that the portion capsule (2) comprises an identifier and that the brewing device (5) comprises an identifier detector (50) for the identification of the identifier of the portion capsule (2), wherein the identifier detector (50) comprises a magnetic switch, which is activated by a magnet arranged on or in the portion capsule (2), the magnetic field of which functions as identifier.

13. System (1) according to claim 12, wherein the magnetic switch is arranged in one or both of the area of the insertion shaft (42) and in the area of the brewing chamber (1′).

14. System (1) according to claim 12, wherein the identifier detector (50) comprises an induction measuring device (53) for measuring an electromagnetic field induced by the portion capsule (2), wherein the induction measuring device (53) is, in particular, integrated into the wall of the insertion shaft (42), through which the portion capsule (2) falls in the direction of the brewing chamber (1′) under the influence of gravity when the brewing device is being loaded.

15. System (1) according to claim 12, wherein the system (1) comprises an automatic capsule feeding system for the feeding of portion capsules (2) into the brewing device (5), wherein the identifier detector (50) is integrated into the capsule feeding system.

16. System (1) according to claim 12, wherein the system (1) comprises a memory for the storage of reference identifiers and a comparison unit for comparing the identifier of the portion capsule (2) detected by means of the identifier detector (50) with the reference identifiers stored in the memory.

17. System (1) according to claim 12, wherein the closure element (3) comprises a capsule stop (12), on which a capsule flange (27) of the portion capsule (2) in the loading position (10) comes to rest, wherein the brewing device (5) comprises an actuator, which pushes the portion capsule (2) from the capsule stop (12), when the identifier of the portion capsules (2) cannot be identified.

18. Method for the preparation of a beverage by means of a system (1) according to claim 1, wherein, in a first step, the portion capsule (2) is inserted into the brewing device (5), wherein, in a second step, the identifier of the portion capsule (2) is identified by means of the identifier detector (50) and wherein, in a third step, the portion capsule (2) is transferred into the brewing chamber (1′) and/or the extraction process is started, when the identifier of the portion capsule (2) has been identified.

19. Method according to claim 18, wherein, in the second step, the detected identifier is compared with stored reference identifiers.

20. Method according to claim 19, wherein, in the second step, the conductivity of the portion capsule (2) is measured by means of a resistance measuring device, a magnetic field induced by the movement of the portion capsule (2) through the insertion shaft (42) is measured by means of an induction measuring device (53), or the identifier of the portion capsule (2) is identified by means of a magnetic switch.

21. (canceled)

22. (canceled)

23. (canceled)
